(19) United States
(12) Patent Application Publication
(10) Pub. No.: US 2026/0044705 A1
(43) Pub. Date: Feb. 12, 2026

(54) SYSTEM AND METHOD FOR RECONFIGURABLE MODULAR NEUROSYNAPTIC COMPUTATIONAL STRUCTURE

(71) Applicant: INNATERA NANOSYSTEMS B.V., Rijswijk (NL)

(72) Inventor: Amir ZJAJO, Rijswijk (NL)

(21) Appl. No.: 19/102,430

(22) PCT Filed: Aug. 16, 2023
(86) PCT No.: PCT/EP2023/072597

§ 371 Date: Feb. 10, 2025

Related U.S. Application Data
(60) Provisional application No. 63/398,243, filed on Aug. 16, 2022.

(51) Int. Cl. G06N 3/04; G06N 3/063

(52) U.S. Cl. CPC G06N 3/04; G06N 3/063

(57) ABSTRACT

The present invention discloses a neurosynaptic structure for a spiking neural network, wherein the neurosynaptic structure comprises: one or more input ports, one or more synaptic elements, each synaptic element connected to at least one of the input ports and configured to receive an input signal and to output a weighted postsynaptic signal. Furthermore, the neurosynaptic structure comprises a neuron connected to the one or more synaptic elements. The neurosynaptic structure is provided with different feedback and control structures such as AMPA-, GABA-, and NMDA receptors, axon-, dendrite- and neuron back-propagation channels and/or an astrocytes structure.

### TECHNICAL FIELD

This disclosure generally relates to automatic signal recognition techniques, and more particularly, to system and method for reconfigurable modular neurosynaptic computational structure that allows increased flexibility and efficacy of signal processing units and enables complex spatio-temporal and plastic behaviour in networks of spiking neurons.

### BACKGROUND

A quest to minimize energy per inference or specific task (such as the one denominated as energy-proportional systems or always optimal circuits, i.e. systems with some form of dynamic feedback control or adaptability), requires codesign across the compute stack (so that the algorithms and applications can influence the underlying hardware design, and similarly the underlying hardware implementation can fit a particular application's needs or constraints), large degree hardware-software co-optimization (towards minimizing network size for given accuracy/maximizing number of operations within allowed power envelope), and fully modular and flexible hardware system to unify design process.

Smart sensor systems are not only adept on modifying or regulating its internal processes or capabilities, but also capable of (based on new information) to modify or alert or to refocus/enable anticipation within the system. Accordingly, the inference machine associated with such smart system continually updates its knowledge of set of internal and external parameters. To conserve space, time, and energy, new information is stored at the synaptic site where it is processed and from where it can be efficiently recalled.

For short-term memories, short-term changes in input are relayed through low-level synapses. High-level synapses encode (quantity of) information after multiple processing stages, hence, their memories are longer and encoded more stably, by enhancing synaptic capabilities and allocating additional ones.

Reconfigurable neuromorphic networks, typically, comprise of the circuits that only partially include receptor, dendritic, and subsequently, synaptic properties. Typical neurosynaptic array comprise of a neural network matrix that connects n×n (or some division of) programmable synapses to n neurons. However, specifying neurosynaptic computational structure that stipulates and facilitates complex spatio-temporal spiking behaviour and consolidate plasticity includes both, functional modification of neurosynaptic elements, and structural mechanisms (circuit reconfiguration by synapse genesis, i.e. formation, elimination, remodelling, degeneration). These include a large variety of receptors and dendritic channels (see e.g., I. Segev, M. London, “Untangling dendrites with quantitative models”, Science, vol. 290, pp. 744-750, 2000), which alter synaptic response by amplification, regulation, the dendritic structure scaling, etc., in addition to multiple forms of short- and long-term plasticity, plasticity of intrinsic excitability, multi-receptor plasticity, and non-Hebbian plasticity, including homeostatic synaptic scaling and meta-plasticity, and rapid structural (synapses and dendritic) plasticity. Accordingly, a generic synapse structure (as a simple point-processing unit) does not capture the diverse temporal dynamics of different types of receptors in biological synapses, which are essential for realization of biophysically accurate neural behaviours in spiking neural networks (SNN). See e.g., A. Morrison, M. Diesmann, W. Gerstner, “Phenomenological models of synaptic plasticity based on spike timing,” Biolog. Cybern., vol. 98, no. 6, pp. 459-478, 2008.

### SUMMARY OF INVENTION

The present invention relates to enabling hierarchical, modular hardware platform that facilitates heterogeneity of the computational elements and systems, but also enable targeted reconfigurability, full programmability and parameter adaptability. This modularity and enabling of heterogeneity mean that the system or system definitions can be reused, and that the parts of the system can be tuned/adjusted accordingly. With compartmentalization, complexing and reconfigurability, the neurosynaptic resources are rationed to the signal that they need to process; a reliable signal requires multiple synapses to conserve signal-to-noise ratio, however, when signal-to-noise ratio is low, fewer synapses can be used, thereby avoiding wasteful excess capacity. Furthermore, to maximize efficiency, signals are concentrated/sparsified in space and time (i.e. information is concentrated at every hierarchical scale); thus, highly active computational elements (e.g. neurons, synapses) are spatially concentrated in specific regions, while their activity is temporally concentrated. Signal processing is performed in continuous-time (analog) domain to maximize the information rates. In addition, hierarchical, modular approach enables implementation of plasticity mechanisms at different timescales (e.g. short-term, long-term, homeostatic, structural plasticity) and, subsequently across different integration verticals. Consequently, compensation can be performed on different levels in both time and space, and across different framework modularity, along the different compute stack, on a circuit level, system and architecture level.

This modular framework facilitates the advantages of (biological/spiking) signal processing at different levels of time-granularity or hierarchy, and enables full software/hardware co-alignment in terms of distributed processing, neural network definitions and mapping.

According to a first aspect a neurosynaptic structure for a spiking neural network is disclosed, wherein the neurosynaptic structure comprises a plurality of synaptic elements and a neuron. Each synaptic element can comprise: one or more input ports, each input port configured to receive an input signal; an output port configured to output a post-synaptic signal; and a signal path connecting the one or more input ports to the output port, the signal path including a weight element configured to apply a weight for generating the postsynaptic signal. The signal path of at least a portion of the synaptic elements may include an AMPA receptor configured to integrate the input signal to cause the postsynaptic signal to be more excitatory. The signal path of at least a portion of the synaptic elements may include a GABBA receptor configured to integrate the input signal to cause the postsynaptic signal to be more inhibitory. The neuron may comprise a soma and an axon, wherein the soma may be configured to receive and combine one or more of the postsynaptic signals, and the axon may be configured to generate a spike output when a membrane potential of the neuron reaches a predetermined threshold in response to an output of the soma.

According to an embodiment of the first aspect, at least one of the synaptic elements may comprise a signal path including both an AMPA receptor and a GABBA receptor. The at least one synaptic element may be configured to combine outputs from the AMPA receptor and the GABBA receptor for generating the postsynaptic signal.

According to an embodiment of the first aspect, the AMPA receptor and/or the GABBA receptor of the neurosynaptic elements may be configurable to be active or passive at a particular moment, and/or the AMPA receptor and/or the GABBA receptor of the neurosynaptic elements may be configurable to select a frequency range of the input signal at which the AMPA receptor and/or the GABBA receptor are operable.

According to an embodiment of the first aspect, the weight element may be positioned after the AMPA receptor and/or the GABBA receptor along the signal path.

According to an embodiment of the first aspect, the weight element may be dynamically adjustable, preferably by modulating the weight element.

According to an embodiment of the first aspect, the AMPA receptor comprises a voltage-driven integrator configured to generate an excitatory postsynaptic current for inducing charge influx from the membrane potential of the neuron, and/or the GABBA receptor is a voltage-driven integrator configured to generate an inhibitory postsynaptic current for inducing charge outflow from the membrane potential of the neuron. The AMPA and/or GABBA receptors may be formed using one or more gm-C filters. The AMPA receptor may be configured to mediate a glutamatergic synaptic current to drive the soma of the neuron and/or the GABBA receptor may drive rapid Hebbian weakening of the synaptic element. The GABBA receptor preferably may have a comparable temporal dynamic behaviour as the AMPA receptor.

According to a second aspect, a neurosynaptic structure for a spiking neural network is disclosed. The neurosynaptic structure comprises plurality of synaptic elements and a neuron. Each synaptic element comprises: one or more input ports, each input port configured to receive an input signal; an output port configured to output a post-synaptic signal; and a signal path connecting the one or more input ports to the output port, the signal path including a weight element configured to apply a weight for generating the postsynaptic signal. The neuron may comprise a soma and an axon, wherein the soma is configured to receive and combine one or more of the postsynaptic signals, and the axon is configured to generate a spike output when a membrane potential of the neuron reaches a predetermined threshold in response to an output of the soma. The neurosynaptic structure may furthermore comprise an axon back-propagation signal path connected to receive an axon signal from the axon of the neuron. The axon back-propagation signal path may comprise an axon back-propagation receptor configured to integrate the axon signal. A first subset of the synaptic elements may be configured to receive the integrated axon signal and modulate the weight element of the first subset of synaptic elements based on the integrated axon signal.

According to an embodiment of the second aspect, each of the synaptic elements of the first subset of the synaptic elements may comprise an NMDA receptor configured to integrate the input signal to form an integrated NMDA signal. The synaptic elements of the first subset of the synaptic elements may be configured to combine the integrated NMDA signal and the integrated axon signal and modulate the weight element of the synaptic element based on the combined signal.

According to an embodiment of the second aspect, the integrated axon signal may be time-differentiated by a derivation unit, preferably a differentiator, before the differentiated integrated axon signal is used to modulate the weight element.

According to an embodiment of the second aspect, the axon back-propagation receptor may be a voltage-driven pure integrator, preferably the axon back-propagation receptor is formed using one or more gm-C filters.

According to an embodiment of the second aspect, at least two axon back-propagation receptors may be used for back-propagation to at least two sets of synaptic elements.

According to an embodiment of the second aspect, the neurosynaptic structure may also be the neurosynaptic structure according to the first aspect.

According to a third aspect, a neurosynaptic structure for a spiking neural network is disclosed. The neurosynaptic structure may comprise a plurality of synaptic elements and a neuron. Each synaptic element comprises: one or more input ports, each input port configured to receive an input signal; an output port configured to output a post-synaptic signal; and a signal path connecting the one or more input ports to the output port, the signal path including a weight element configured to apply a weight for generating the postsynaptic signal. The neuron may comprise a soma and an axon, wherein the soma may be configured to receive and combine one or more of the postsynaptic signals, and the axon may be configured to generate a spike output when a membrane potential of the neuron reaches a predetermined threshold in response to an output of the soma. The neurosynaptic structure may furthermore comprise a dendrite back-propagation signal path configured to receive and combine the postsynaptic signal from one or more of the synaptic elements. The dendrite back-propagation signal path may comprise a dendrite receptor configured to integrate the combined postsynaptic signal. A second subset of the synaptic elements may be configured to receive the integrated combined postsynaptic signal and modulate the weight element of the second subset of the synaptic elements based on the integrated combined postsynaptic signal.

According to an embodiment of the third aspect, each of the synaptic elements of the second subset of the synaptic elements may comprise an NMDA receptor configured to integrate the input signal to form an integrated NMDA signal. The synaptic elements of the second subset of the synaptic elements may be configured to combine the integrated NMDA signal and the integrated combined postsynaptic signal and modulate the weight element of the synaptic element based on the combined signal.

According to an embodiment of the third aspect, the integrated combined postsynaptic signal may be time-differentiated by a derivation unit, preferably a differentiator, before the differentiated integrated summed postsynaptic signal is used to modulate the weight element.

According to an embodiment of the third aspect, the dendrite receptor may be a voltage-driven pure integrator, preferably the dendrite receptor may be formed using one or more gm-C filters.

According to an embodiment of the third aspect, the neuron may be configured to receive the one or more postsynaptic signals from the one or more synaptic elements at the soma via a second dendrite receptor which integrates the combined postsynaptic signal of each of the one or more synaptic elements. Preferably the dendrite receptor is a voltage-driven pure integrator, more preferably the dendrite receptor is formed using one or more gm-C filters.

According to an embodiment of the third aspect, the one or more postsynaptic signals may be combined at the soma by combining the combined, preferably also integrated, postsynaptic signal of each of the synaptic elements in the second subset with one or more postsynaptic signals from the one or more synaptic elements not in the second subset. Preferably the one or more synaptic elements not in the second subset are also connected to the neuron via one or more different dendrite structures.

According to an embodiment of the third aspect, the neurosynaptic structure is also the neurosynaptic structure of the first and/or second aspect.

According to a fourth aspect, a neurosynaptic structure for a spiking neural network is disclosed. The neurosynaptic structure may comprise a plurality of synaptic elements and a neuron. Each synaptic element may comprise: one or more input ports, each input port configured to receive an input signal; an output port configured to output a post-synaptic signal; and a signal path connecting the one or more input ports to the output port, the signal path including a weight element configured to apply a weight for generating the postsynaptic signal. The neuron may comprise a soma and an axon, wherein the soma is configured to receive and combine one or more of the postsynaptic signals, and the axon is configured to generate a spike output when a membrane potential of the neuron reaches a predetermined threshold in response to an output of the soma. The neuron may comprise a neuron back-propagation signal path which may connect from the axon of the neuron to the soma of the neuron and which may comprise a local receptor configured to integrate the axon signal and a calcium element configured to set the influence of the integrated axon signal thus creating a neuron feedback signal. The neuron back-propagation signal path may be configured to feed the neuron feedback signal to the soma of the neuron where the neuron feedback signal may be combined with the one or more postsynaptic signals.

According to an embodiment of the fourth aspect, the calcium element may be an amplifier, preferably a faster amplifier than the weight element of each synaptic element. Additionally or alternatively, the calcium element may provide adaptable feedback.

According to an embodiment of the fourth aspect, the local receptor may be a voltage driven pure integrator. Preferably, the local receptor is formed using one or more gm-C filters.

According to an embodiment of the fourth aspect, the neurosynaptic structure may also be the neurosynaptic structure according to the first, second and/or third aspect.

According to a fifth aspect, a neurosynaptic structure for a spiking neural network is disclosed. The neurosynaptic structure may comprise a plurality of synaptic elements and a neuron. Each synaptic element may comprise: one or more input ports, each input port configured to receive an input signal; an output port configured to output a post-synaptic signal; and a signal path connecting the one or more input ports to the output port, the signal path including a weight element configured to apply a weight for generating the postsynaptic signal. The neuron may comprise a soma and an axon, wherein the soma is configured to receive and combine one or more of the postsynaptic signals, and the axon is configured to generate a spike output when a membrane potential of the neuron reaches a predetermined threshold in response to an output of the soma. The neurosynaptic structure may comprise an astrocyte structure connected to a third subset of the synaptic elements. The astrocyte structure may be configured to receive and sum the postsynaptic signals of each of the synaptic elements and may comprise a modulation circuit configured to modulate the summed postsynaptic signal into a modulated signal. The modulated signal may be used to change the behaviour at one or more of the synaptic elements of the third subset or at the neuron.

According to an embodiment of the fifth aspect, the astrocyte structure may comprise an mGluR receptor configured to integrate the modulated signal. The astrocyte structure may be configured to output the integrated modulated signal to each of the synaptic elements in the third subset. Each of the multiple synaptic elements may be configured to combine the integrated modulated signal with an integrated input signal. The integrated input signal may be obtained from integrating the input signal using an AMPA and/or a GABBA receptor positioned along the signal path configured to integrate the input signal.

According to an embodiment of the fifth aspect, the mGluR receptor may be a voltage-driven pure integrator. Preferably, the mGluR receptor is formed using one or more gm-C filters.

According to an embodiment of the fifth aspect, the astrocyte structure may comprise an NMDA receptor configured to integrate the modulated signal. The astrocyte structure may be configured to output the integrated modulated signal to the neuron.

According to an embodiment of the fifth aspect, the neuron may comprise a neuron back-propagation signal path connecting the axon to the soma of the neuron and which may comprise a calcium element configured to set the influence of the integrated axon signal to create a neuron feedback signal. The neuron back-propagation signal path may be configured to feed the neuron feedback signal to the soma of the neuron. The integrated modulated signal may modulate the calcium element of the neuron to change the influence of the integrated axon signal of the neuron.

According to an embodiment of the fifth aspect, the modulation circuit may comprise an IP3 receptor configured to integrate the summed postsynaptic signal and an astrocyte calcium element configured to set the influence of the modulated signal. The IP3 receptor and the astrocyte calcium element may generate the modulated signal.

According to an embodiment of the fifth aspect, the IP3 receptor may be a voltage-driven pure integrator. Preferably the IP3 receptor is formed using one or more gm-C filters. Additionally or alternatively, the astrocyte calcium element may be an amplifier, preferably a faster amplifier than the weight element of each synaptic element. Additionally or alternatively, the astrocyte calcium element may provide adaptable feedback.

According to an embodiment of the fifth aspect, the neurosynaptic structure may comprise synaptic elements which do not directly connect with the neuron. The astrocyte calcium element may be modulated using pre-synaptic neuron signals or postsynaptic signals coming from the synaptic elements which do not directly connect with the neuron and which may be integrated using a dendrite receptor.

According to an embodiment of the fifth aspect, the axon of the neuron may be connected to the astrocyte structure, so that an axon back-propagation receptor of the astrocyte can be configured to integrate the axon signal of the neuron. The integrated axon signal may be used to modulate the astrocyte calcium element.

Preferably, the integrated axon signal may be combined with other axon back-propagation signals from other neurons comprised in the neurosynaptic structure thus forming a combined axon signal. The combined axon signal may be used to modulate the astrocyte calcium element. More preferably, a time derivative is taken of the combined axon input signal by a derivation unit, even more preferably wherein the derivation unit is a differentiator.

According to an embodiment of the fifth aspect, the neurosynaptic structure may also be the neurosynaptic structure according to the first, second, third and/or fourth aspect.

According to a sixth aspect a method for controlling a neurosynaptic structure for a spiking neural network is disclosed, wherein the neurosynaptic structure comprises a plurality of synaptic elements and a neuron. Each synaptic element can comprise: one or more input ports, each input port configured to receive an input signal; an output port configured to output a post-synaptic signal; and a signal path connecting the one or more input ports to the output port, the signal path including a weight element configured to apply a weight for generating the postsynaptic signal. The signal path of at least a portion of the synaptic elements may include a GABBA receptor configured to integrate the input signal to cause the postsynaptic signal to be more inhibitory. The neuron may comprise a soma and an axon, wherein the soma may be configured to receive and combine one or more of the postsynaptic signals, and the axon may be configured to generate a spike output when a membrane potential of the neuron reaches a predetermined threshold in response to an output of the soma. The method may start by receiving the input signal at the synaptic element. Thereafter, the input signal may be integrated in order to cause the postsynaptic signal to be more excitatory and/or inhibitory.

According to a seventh aspect, a method for controlling a neurosynaptic structure for a spiking neural network is disclosed. The neurosynaptic structure comprises plurality of synaptic elements and a neuron. Each synaptic element comprises: one or more input ports, each input port configured to receive an input signal; an output port configured to output a post-synaptic signal; and a signal path connecting the one or more input ports to the output port, the signal path including a weight element configured to apply a weight for generating the postsynaptic signal. The neuron may comprise a soma and an axon, wherein the soma is configured to receive and combine one or more of the postsynaptic signals, and the axon is configured to generate a spike output when a membrane potential of the neuron reaches a predetermined threshold in response to an output of the soma. The method may comprise receiving an axon signal from the axon of the neuron. Subsequently, the received axon signal may be integrated. The integrated axon signal may be received at a first subset of the synaptic elements. Next, the weight element of the first subset of synaptic elements may be modulated based on the integrated axon signal.

According to an eight aspect, a method for controlling a neurosynaptic structure for a spiking neural network is disclosed. The neurosynaptic structure may comprise a plurality of synaptic elements and a neuron. Each synaptic element comprises: one or more input ports, each input port configured to receive an input signal; an output port configured to output a post-synaptic signal; and a signal path connecting the one or more input ports to the output port, the signal path including a weight element configured to apply a weight for generating the postsynaptic signal. The neuron may comprise a soma and an axon, wherein the soma may be configured to receive and combine one or more of the postsynaptic signals, and the axon may be configured to generate a spike output when a membrane potential of the neuron reaches a predetermined threshold in response to an output of the soma. The method may comprise receiving and combining the postsynaptic signal from one or more of the synaptic elements. Next, the combined postsynaptic signal may be integrated. The integrated combined postsynaptic signal may be received at a second subset of the synaptic elements, which may modulate the weight element of the second subset of the synaptic elements based on the integrated combined postsynaptic signal.

According to a nineth aspect, a method for controlling a neurosynaptic structure for a spiking neural network is disclosed. The neurosynaptic structure may comprise a plurality of synaptic elements and a neuron. Each synaptic element may comprise: one or more input ports, each input port configured to receive an input signal; an output port configured to output a post-synaptic signal; and a signal path connecting the one or more input ports to the output port, the signal path including a weight element configured to apply a weight for generating the postsynaptic signal. The neuron may comprise a soma and an axon, wherein the soma is configured to receive and combine one or more of the postsynaptic signals, and the axon is configured to generate a spike output when a membrane potential of the neuron reaches a predetermined threshold in response to an output of the soma. The method may comprise integrating a signal of the axon. Furthermore, the influence of the integrated axon signal may be set, thus creating a neuron feedback signal. Next, the neuron feedback signal may be fed to the soma of the neuron where the neuron feedback signal may be combined with the one or more postsynaptic signals.

According to a tenth aspect, a method for controlling a neurosynaptic structure for a spiking neural network is disclosed. The neurosynaptic structure may comprise a plurality of synaptic elements and a neuron. Each synaptic element may comprise: one or more input ports, each input port configured to receive an input signal; an output port configured to output a post-synaptic signal; and a signal path connecting the one or more input ports to the output port, the signal path including a weight element configured to apply a weight for generating the postsynaptic signal. The neuron may comprise a soma and an axon, wherein the soma is configured to receive and combine one or more of the postsynaptic signals, and the axon is configured to generate a spike output when a membrane potential of the neuron reaches a predetermined threshold in response to an output of the soma. The method may comprise receiving and summing the postsynaptic signals of each of the synaptic elements. Next, the summed postsynaptic signal may be modulated into a modulated signal. Next, the behaviour at one or more of the synaptic elements of the third subset or at the neuron is changed using the modulated signal.

### BRIEF DESCRIPTION OF THE DRAWINGS

Embodiments will now be described, by way of example only, with reference to the accompanying drawings in which corresponding reference symbols indicate corresponding parts, and in which:

FIG. 1A shows a typical implementation of a neurosynaptic array, FIG. 1B shows a corresponding representation of a synaptic column with nominal (AMPA-like) synaptic integration and weight multiplication and neuron summation;

FIG. 2 shows a representation of a synaptic column with AMPA synaptic integration and weight multiplication and neuron summation, but also including GABA (inhibitory) receptors;

FIG. 3 shows a representation of a synaptic column with AMPA synaptic integration and weight multiplication and neuron summation, but also including GABA (inhibitory) receptors, and further extending this representation with NMDA receptors and corresponding axon (backpropagated) feedback system;

FIG. 4 shows a schematic representation of a reconfigurable modular network comprising of neuromorphic synapses with multiple receptors, and dendrite and axon feedback signals, respectively;

FIG. 5 shows a schematic representation of a reconfigurable modular network comprising of neuromorphic synapses with multiple receptors, adaptive exponential neurons, and an astrocytes system;

FIGS. 6A and 6B show coordinated events in a source population convey feedforward a) excitation, and b) inhibition; the shift to higher excitation/inhibition sets neurons in a fast/slow firing behavior with sparse bursts; for each synchrony partition a population of postsynaptic neurons is assigned; synchrony partitions are mapped to patterns of postsynaptic activity.

### DESCRIPTION OF EMBODIMENTS

Hereinafter, certain embodiments will be described in further detail. It should be appreciated, however, that these embodiments should not be construed as limiting the scope of protection for the present disclosure.

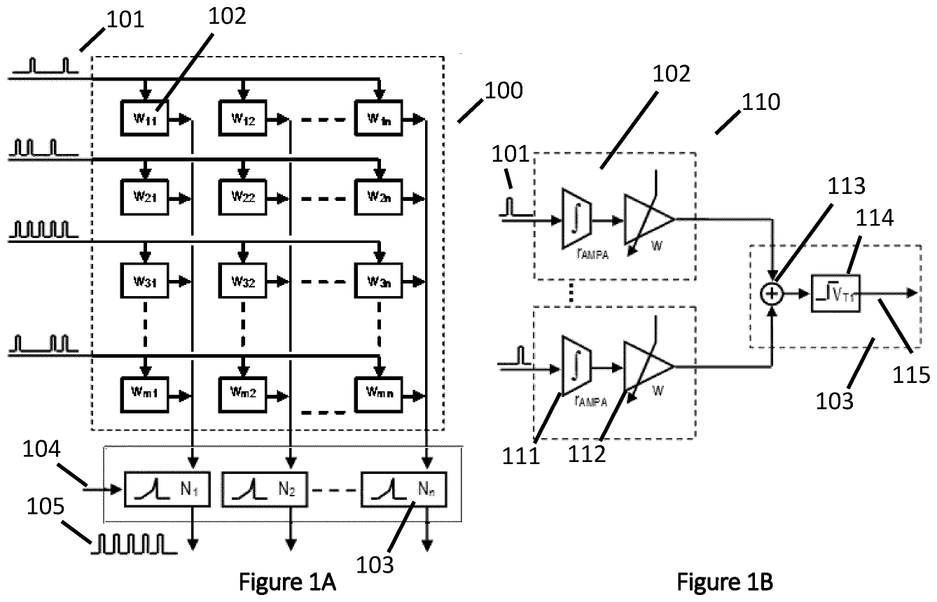

FIG. 1A shows a typical implementation of a neurosynaptic array 100 of a spiking neural network (SNN).

In the present embodiment, the neurosynaptic array comprises m×n synapses 102, with respective synaptic weights w_{i,j} with i ∈{1, . . . , m} and j∈{1, . . . , n} connecting m input signals 101 (for example a digital or analog input pulse, preferably a voltage spike) to a n neurons 103 denoted by Nₖ with k ∈{1, . . . , n}. Each neuron integrates incoming signals and may fire a spike signal 105 which forms a spatio-temporal spike train when a particular membrane potential threshold is reached. In this example, an input signal 101 may be fed to a row of synapses 102, and each column of synapses may be fed to a particular neuron 103. In general, an input signal 101 may be fed through one or more synapses 102 to one or more neurons 103. The synaptic array and its connections may be dynamically adaptable in order to optimize performance and power consumption of the spiking neural network.

The input signals 101 could be from various sources such as sensors, images, audio, or any other form of data. Each synapse 102 between neurons in an SNN is associated with a synaptic weight, which determines the strength of the connection. During learning, the synaptic weights may be adjusted to optimize the network's performance on a specific task. The neurons 103 integrate incoming signals from e.g., the input connections or other connected neurons via synapses 102. The neuron's membrane potential is updated based on the incoming spikes from connected neurons, weighted by the synaptic strengths w_{i,j} The neurons 103 fire spikes when their membrane potential crosses a certain threshold value.

The neurons 103 can produce complex spatio-temporal spike patterns that contribute to the network's processing capabilities. SNNs can adapt and learn from data through synaptic plasticity mechanisms. This means that the synaptic weights w_{i,j} can change over time based on the patterns of spikes and their timings. Learning rules are used to adjust the weights to improve the network's performance on a given task.

In general, the neurosynaptic structure, for example implemented in a spiking neural network core employs a mixed analog-digital computational platform, i.e. the spike trains can incorporate analog information in the timing of the events, which may be subsequently transformed back into analog representation at the inputs of the synaptic matrix. Each mixed analog/digital core may comprise of an input decoder that connects m×n programmable synapses to n neurons, and the I/O network communication layer. Neurosynaptic computational elements can generate complex spatio-temporal dynamics, extendable towards specific features that can aid target signal processing function. The neuron spiking properties may be controlled through the specific parameter sets. Topology of neurosynaptic elements control the regularity of spontaneous neuronal spiking, e.g., a firing rate scaling factor and the intensity of intrinsic noise, yielding a coherence/resonance occurrence.

A core router (connected to the rest of the network via an I/O port) of the spiking neural network core may provide input spikes to a row decoder. The row decoder takes the input spikes and may determine to which row of the synaptic array certain parts of the signal are transferred. Learning and adaptation modules may be present. Furthermore, a column decoder may be present which takes the output of a column of synaptic elements and sends the output of the decoded column to one or more neurons. The neuron configuration can be changed by a neuron control module, which also can obtain feedback from the learning and adaptation module. Spikes from the one or more neurons may be sent via the core router to other cores of the spiking neural network.

The structures shown can all be realized using electronic circuits, either fully in hardware, or at least partly in hardware.

FIG. 1B shows a corresponding representation with respect to FIG. 1A of a typical synaptic column with nominal (AMPA-like) synaptic integration and weight multiplication and neuron summation. FIG. 1B represents a particular implementation of a single column of synapses 102 out of the synaptic array of FIG. 1A, connecting to a particular neuron 103.

Each synapse 102 in this exemplary embodiment comprises a AMPA receptor r_{AMPA} 111 which acts as an integrator, connected to a synaptic weight 112 which can be adjustable. An integrator can be an element whose output signal is the time integral of its input signal. The integrator may accumulate the input quantity over a defined time to produce a representative output.

The AMPA receptor 111 can be a component that simulates the behavior of biological AMPA receptors at synapses. It is used to capture the way excitatory synaptic transmission occurs in the brain and integrates the input signal 101 over time, simulating the buildup of excitatory currents as in a biological synapse.

Each synapse 102 may comprise an associated weight 112 that represents the strength of the connection. When a spike arrives as an input signal to the synapse (e.g., from a presynaptic neuron or from an encoder), the spike signal can be integrated by the AMPA receptor after which the weight w_{i,j} of the synapse 102 may be applied to the spike. Vice versa, when a spike arrives as an input signal to the synapse (e.g., from a presynaptic neuron or from an encoder), the weight w_{i,j} of the synapse 102 is applied to the spike, and the resulting contribution can be integrated by the “AMPA receptor” unit, i.e., the order of integration and weight application may be reversed.

The soma 113 of the neuron 103 may serve as the location where incoming signals are integrated. These incoming signals are typically spikes (discrete events), and they arrive from the neuron's input synapses 102. This causes the neuron's membrane potential to change, and when a certain threshold is reached the neuron 103 may fire, in particular the neuron may fire from the axon 115 of the neuron 103. Once the artificial neuron 103 generates an output spike, it is transmitted along the axon 115 of the neuron further to e.g., other neurons that the current neuron is connected to. This transmission of spikes mimics the propagation of action potentials along biological axons. Furthermore, a signal restoration unit 114 may be present in the neuron, which may restore a signal after signal decay has taken place. The signal restoration unit 114 may comprise for example a digital buffer.

Without loss of generality, to compute most efficiently in space and energy, i.e., to minimize energy per bit of information, the present invention enables computing in a modular multi-layered way across the different hierarchical granularities, where each hierarchical level is optimized or selected based on the least associated costs. Hence, in this multi-layer structure, each set of basic signal processing components is modularly combined, e.g., synaptic integration is regulated through gain-bandwidth product characteristics, subsequent weight application/retention mechanism is governed by digital code-to-current transfer (i.e., digital (signal)-to-analog (current) conversion), and eventual spike generation derived through current-to-frequency transfer characteristics controlled through among others an adaptive mechanism to match a current to circumstance. This route to efficiency is followed in an integrated system across different hierarchical levels while preserving the information embodied as signal-to-noise ratio (SNR) and bandwidth. Structural implications are valid across different levels of hierarchy, at finer scales and lower levels, and at larger scales and higher levels, i.e., diverse circuits allow the inference machine to send only relevant information and at lower information rates, offering competitive computation performance/associated cost curve.

The multi-layer neurosynaptic structure enables different (e.g., rapid, slow, depression, potentiation) responses on input stimuli governed by several mechanisms like a non-competitive, homosynaptic plasticity driven by residual activity, a competitive hetero-synaptically driven neighboring-aware process, or mediate potentiation and homeostatic regulation in responses to active inputs during normal sensory use. The model allows assignment of various neuronal characteristics, e.g., axonal and dendritic delays, synaptic transfer functions, offers computation of the optimal input-output transfer function and distinctive signal processing functions such as filtering, amplification, multiplication, addition, etc., allows spike train kernel convolution in the time domain.

In the integrated neuromorphic system, the sensed signal, once encoded, spreads passively (down the axon) to the synaptic terminal. If the physical distance on chip is short enough for passive signalling (i.e., do not deteriorate the signal sufficiently (for example governed by the exponential decay

$${e}^{- ( \frac{t}{tau} )} ) ,$$

and hence the buffering/signal restoration is not needed), the inference machine can directly read out the (analog, and hence with very high efficiency) encoded information. If the inference machine's analog signal contains more information than action potentials can encode, on-site processing is required. Optimization of silicon circuits for the best performance vs. associated cost (e.g. space, time, energy) might require large diversity of circuit structures at all spatial scales. Note that passive signals spread spatially and temporally only as the square root of dendritic/synaptic column wire diameter.

The present invention tries to solve this issue by proposing more adaptable synaptic structures. The proposed structures built on the embodiment shown in FIG. 1A and FIG. 1B. Similar features will not be repeated, and can be readily combined discussed in relation to these embodiments.

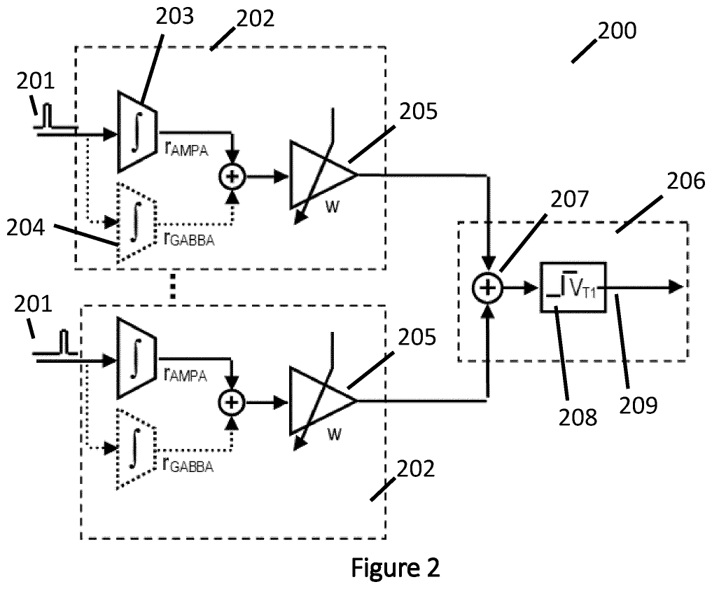

FIG. 2 shows a representation of a synaptic column with AMPA synaptic integration and weight multiplication and neuron summation, but also including GABA (inhibitory) receptors.

The synaptic structure 200 comprises synapses 202 (also called synaptic elements) comprising an AMPA receptor 203 and/or GABA receptor 204. Each receptor can exhibit different temporal dynamics in the response to an input signal. For example, each receptor may act as a filter for different frequencies.

The receptors elicit excitatory and inhibitory postsynaptic current (EPSC and IPSC) respectively, inducing charge influx and outflow from membrane voltage. AMPA receptors mediate a fast (glutamatergic) synaptic current to drive the soma of a postsynaptic neuron. AMPA receptors have a high response speed to transmitter binding both in rise and decay phases due to both fast removal of transmitters and quick channel closure. See S. Hestrin, “Activation and desensitization of glutamate-activated channels mediating fast excitatory synaptic currents in the visual cortex,” Neuron, vol. 9, no. 5, pp. 991-999, 1992.

GABA receptors are the main fast IPSCs contributor, see A. Destexhe, Z. F. Mainen, T. J. Sejnowski, “Kinetic models of synaptic transmission,” Meth. Neuron. Model., vol. 2, pp. 1-25, 1998. Conversely, deprivation decreases the magnitude of inhibitory postsynaptic currents onto principal neurons and preferentially reduces activation of fast spiking inter-neurons. The inhibition mediated by GABA receptors is a prerequisite for balancing excitation and inhibition, thus stabilizing neural network, and realize fine-grained temporal variation to drive precise plastic behaviour. See S. H. Wu, C. L. Ma, J. B. Kelly, “Contribution of ampa, nmda, and gabaa receptors to temporal pattern of postsynaptic responses in the inferior colliculus of the rat,” J. Neurosc., vol. 24, no. 19, pp. 4625-4634, 2004.

Similarly, in a homeostatic model, deprivation through GABAergic circuits of a subset of inputs drives rapid Hebbian weakening on deprived pathways and more slowly drives a homeostatic increase in global synapse strength and/or intrinsic excitability, which increases responses to spared inputs. The GABA receptors preferably have a comparable temporal dynamic behaviour as AMPA.

A synaptic element 202 is connected to at least one of the input ports 201 and is configured to receive the input signal and to output a postsynaptic signal. A synaptic element 202 comprises an AMPA receptor 203 which is configured to integrate the input signal so as to cause the postsynaptic signal to be more excitatory. Additionally or alternatively, the synaptic element 202 can comprise a GABA receptor 204 configured to integrate the input signal so as to cause the postsynaptic signal to be more inhibitory. Both the AMPA and GABA receptor can be present, but it can dynamically be determined which one is active, and/or which frequency range they filter, i.e., which frequency range these receptors are active on. The output of the AMPA and/or GABA receptors are combined (if necessary, e.g., by summation).

A weight element 205 is also present in the synapse 202. The weight element 205 is configured to set the influence of the postsynaptic signal, by having a particular weight which determines the strength of the connection that the synapse 202 represents. For example, if the weight is higher, the weight element 205 may act to amplify the signal coming from the AMPA receptor and/or GABA receptor. If the weight is lower, the weight element 205 may act to attenuate the signal coming from the AMPA receptor and/or GABA receptor. The weight of the weight element, i.e., its influence, may be dynamically adjustable (e.g., by modulating the weight element 205) or may be static.

The neuron 206 may be the same as the neuron in FIG. 1B. Namely, it may comprise a soma 207, and an axon 209 which may fire once the membrane potential of the neuron 206 reaches a certain threshold. The neuron may thus be configured to receive the postsynaptic signal from at least one synaptic element 202. Note that the again the synaptic elements 202 which are connected to the neuron 206 represent the synaptic elements in the column of the synaptic array of FIG. 1A which are connected to a specific neuron, although other configurations are of course possible.

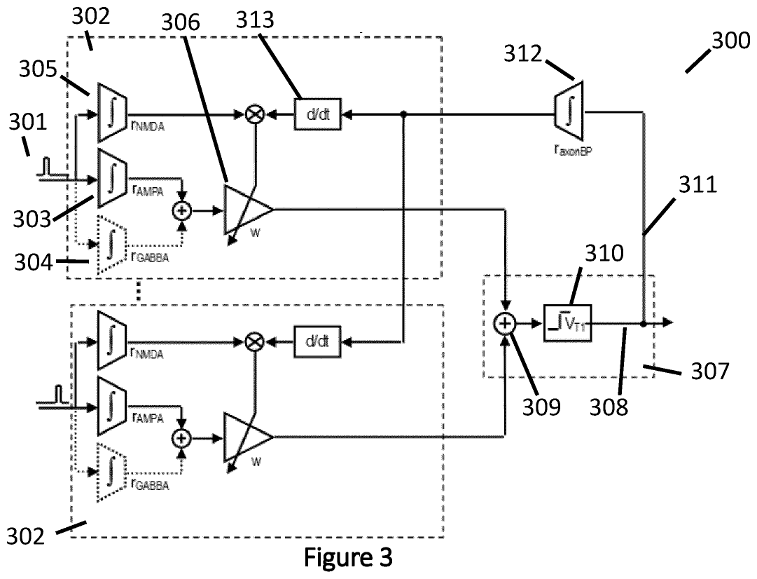

FIG. 3 shows a representation of a synaptic column with AMPA synaptic integration and weight multiplication and neuron summation, but also including GABA (inhibitory) receptors, and further extending this representation with NMDA receptors and corresponding axon (back-propagated) feedback system.

Without loss of generality, all main glutamate receptors, AMPA and NMDA, and GABAa receptor are included, each exhibiting different temporal dynamics in their response to neurotransmitters. The receptors elicit excitatory and inhibitory postsynaptic current (EPSC and IPSC) respectively, inducing charge influx and outflow from membrane voltage. Without loss of generality, scaling of excitatory synapses onto principal neurons is expressed primarily by regulating AMPA receptor insertion, through NMDA potentiation and depression.

NMDA receptor offers activity-dependent modifications of the synaptic weight, i.e., a more complex mechanism including a NMDA receptor-dependent depression, which suppress the mediation process of synaptic AMPA receptors currents, and NMDA potentiation that causes appearance of AMPA receptor currents at weak synapses, hence, functionalizing these synapses. Intrinsic excitability, and excitatory-inhibitory balance are also homeostatically regulated by setting a permissive excitatory-inhibitory balance or editing firing patterns to promote excitatory synaptic plasticity.

The neurosynaptic structure 300 comprises an axon back-propagation signal path 311 connected to the neuron 307 and the at least one synaptic element 302, wherein the axon back-propagation signal path 311 is configured to receive an axon signal from the axon 308 of the neuron 307 and comprises an axon back-propagation receptor 312 configured to integrate the axon signal. The axon back-propagation signal path 311 is configured to output the integrated axon signal to the at least one synaptic element 302. The axon back-propagation receptor 312 can be a pure integrator element, which can be voltage driven.

The at least one synaptic element comprises a NMDA receptor 305 configured to integrate the input signal received at the input port 301 into an integrated NMDA signal. The integrated NMDA signal and the integrated axon signal are combined and modulate the weight element 306 of the at least one synaptic element 302 to change the influence of the postsynaptic signal of the at least one synaptic element 302. Thus, by modulating the weight element 306, the weight of the weight element can be dynamically altered. Note that the integrated axon signal can be used to be combine with the integrated NMDA signal, but it is preferred to use the time derivative of the integrated axon signal. A derivation unit 313 can therefore be placed along the axon back-propagation signal path 311, for example within the synaptic element 302. The derivation unit 313 can be for example a differentiator, which is a circuit designed to produce an output approximately proportional to the rate of change (the time derivative) of the input. The differentiator can essentially be a high-pass filter. An active differentiator may include some form of amplifier, while a passive differentiator may be made only of resistors, capacitors and/or inductors.

The rest of the synaptic elements 302 and neuron 307 may be similar to FIG. 2. Namely, an AMPA 303 and/or GABA 304 receptor may also be present which integrate the input signal and their single or combined output is sent to the weight element 306. The neuron receives the weighted and integrated postsynaptic signal from each synapse 302 connected to the neuron 307 at the soma 309, where the different postsynaptic signals are combined e.g., by summation. A signal restoration unit 310 may be present in the neuron 307. When the membrane potential of the neuron 307 reaches a certain threshold, the neuron may spike via its axon 308.

Note that while every synaptic element 302 is shown with an AMPA, GABA and NMDA receptor, as well as an axon back-propagation signal path 311, this is not required. Some of the synaptic elements which connect to the neuron 307 may only have AMPA receptors and weight elements, some may only have GABA receptors and weight elements, some may have AMPA and GABA receptors and weight elements. A synaptic element may also have a AMPA and/or GABA receptor, as well as a weight element which is modulated by an NMDA receptor and an axon back-propagation signal path 311 (preferably with a derivation unit 313 present).

Note that the weight element 306 can also be modulated on the basis of only the NMDA receptor output, or the output of the axon back-propagation signal path 311 (again, preferably with derivation unit 313).

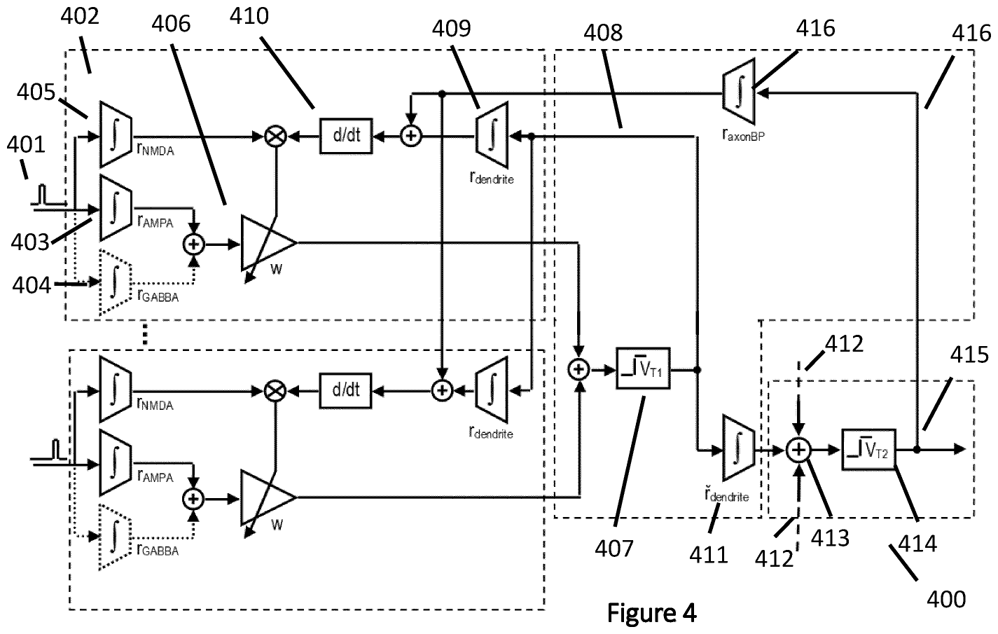

FIG. 4 shows a schematic representation of a reconfigurable modular neurosynaptic structure 400 comprising of neuromorphic synapses with multiple receptors, and dendrite and axon feedback signals, respectively.

The neurosynaptic structure 400 may furthermore comprise a dendrite back-propagation signal path 408 connected to one or multiple synaptic elements 402, wherein the dendrite back-propagation signal path 408 is configured to receive and sum the postsynaptic signal of each of the synaptic elements 402. Preferably, the dendrite back-propagation signal path 408 comprises a signal restoration unit 407, which can have similar workings as signal restoration unit 114. The dendrite back-propagation signal path 408 may comprise a dendrite receptor 409 configured to integrate the summed postsynaptic signal. The dendrite back-propagation signal path 408 is configured to output the resulting integrated summed postsynaptic signal, also called a dendrite signal to each of the one or multiple synaptic elements 402 to which it is connected.

Each of these one or multiple synaptic elements 402 may comprise an NMDA receptor 405 configured to integrate the input signal received at the input port 401 to the synaptic element into an integrated NMDA signal. The integrated NMDA signal and the integrated dendrite signal can be combined and may modulate the weight element 406 of the synaptic element to change the influence of the postsynaptic signal of the at least one synaptic element 402, e.g., on the neuron 414. Note that the integrated dendrite signal can be used to be combined with the integrated NMDA signal, but it is preferred to use the time derivative of the integrated dendrite signal. A derivation unit 410 (similar to the one described above) can therefore be placed along the dendrite back-propagation signal path 408, for example within the synaptic element 402. Preferably, if an axon back-propagation signal path 416 is also present, as in the present exemplary embodiment, the dendrite and axon signals are combined (e.g., by summation of the signals) and thereafter the derivation unit is used to obtain the derivative of the combined signal. Of course, the derivative of both signals can also be separately determined and then combined.

In one embodiment, all synapses which are connected to a particular neuron are also connected to the same dendrite back propagation signal path 408. In that case, the summed postsynaptic signal of each of the synaptic elements may be forwarded to the soma 413 of the neuron. Alternatively, a separate post-dendrite receptor 411 integrates the summed postsynaptic signal before it is sent to the soma 413 of the neuron 414.

In another embodiment, the dendrite is only connected to a specific subset of synaptic elements 402 which connect to the neuron 414. In that case, other synaptic outputs may be received at the soma 413 via other synaptic segment outputs 412. These segments might also have dendrite structures present with a dendrite back-propagation signal path 408. Each dendrite structure may have a separate post-dendrite receptor 411. This is the present exemplary embodiment shown in the figure.

The functionality of the other structures is similar to the embodiment of FIG. 3. Namely, an AMPA 403 and/or GABA 404 receptor may also be present which integrate the input signal and their single or combined output is sent to the weight element 406. The neuron receives the weighted and integrated postsynaptic signal at the soma 413, where the different postsynaptic signals are combined e.g., by summation. A signal restoration unit 407 may be present in the neuron 414. When the membrane potential of the neuron 414 reaches a certain threshold, the neuron may spike via its axon 415. The axon back-propagation signal path 416 may also be present.

Similarly, as mentioned earlier, the different feedback paths may be implemented separately or jointly. Note that the weight element 406 can also be modulated on the basis of only the NMDA receptor output or based only on the output of the dendrite back-propagation signal path 408 (again, preferably with derivation unit 409). This time also optionally in combination with the axon back-propagation signal path 416.

For efficient energy-delay product over small distance a signal is thus converted to current that charges membrane capacitance; for longer distance, the current is regenerated by appropriately clustered voltage-gated NMDA channels. Hence, in the post-synaptic part, the temporal summation of post-synaptic back-propagating spikes, i.e. dendrite and soma spikes, respectively, which initiate a dendritic spike, is completed. Such implementation allows wide range of temporal behaviors as each receptor can operate on different temporal scale, and obtain higher noise tolerance, as the capability of the network to perform pattern recognitions even in noisy signals increase.

If groups (bursts) of dendritic spikes are sufficiently strong to drive the soma, the neuron may generate action potentials; for which the resulting spike may be back-propagated into the dendrite. See R. C. Froemke, Y. Dan, “Spike-timing-dependent synaptic modification induced by natural spike trains”, Nature, vol. 416, pp. 434-438, 2002. The back-propagated dendrite and soma signals can be multiplied and added to NMDA receptor signals to form the weight control signal.

A single receptor is subject to stochastic fluctuations, such as thermal noise; therefore, a neuron might need to improve the signal-to-noise ratio of signals conveyed by one receptor by averaging over a population of the same type. Increasing the number of receptors n improves SNR by √n. However, since it comes with associated higher costs, it is reserved for special purposes, e.g., synapses that transmit with high temporal precision. For the optimal allocation of resources, one can engage noise-resources equation, i.e. trading power and/or area to reduce thermal/flicker noise. If noise is to be minimized, more resources should be distributed to the parts of a system that affect all other parts of it (the initial stages) and to those parts of the system that are complex (i.e., those having a higher number of receptors, denoted by high nᵢ).

In general, in bio-chemical systems noise origins can be traced to the different hierarchical scales: i) biophysical origins (microscopic fluctuations of small structural components of neurons, such as ion channels or the synaptic mechanism involved in vesicle release), ii) dynamics of neural circuits (excitatory/inhibitory behavior, sparsity), iii) global network properties (average instantaneous population activity, synchrony). Similarly, variability effects associated with modern IC manufacturability can be subdivided across chip physical dimensions on different levels of spatial granularity, ranging from global, i.e. on IC level including technology (process corner), electrical (supply voltage), thermal (temperature), lithography (line width), towards local effects, i.e. on sub-circuit (substrate noise, temperature gradient, layer density), transistor (well-proximity, local heating, jitter, cross-talk, aging effects), or atomic (thermal noise, mobility variations, random dopant, mechanical stress, line-edge roughness) level.

The structures shown in the FIGS. 2-5 allow implementation of this hierarchical granularity.

Variability effects when subdivided across different temporal granularity can thus be linked to the methodologies to mitigate performance loss or yield loss, i.e., can be subdivided based on time-dependencies of variability artifacts into static, slow, medium and fast changing events. Static effects, allow a one-time correction of the associated devices in the circuit (e.g., trimming), while slow time-dependent effects, i.e., static within the observation period, can be corrected during operation with on-chip calibration mechanisms. Variations with a time span comparable to the maximum speed of the process (e.g., jitter, substrate noise, kT noise, dynamic IR drop) cannot be calibrated directly, and must be accommodated by stretching of design margins. Comparability, plasticity mechanisms take place at different timescales and, subsequently across different integration verticals, e.g. short-term plasticity (adaptive neuron behaviors, short-term synaptic adaptation), long-term plasticity (spike-based plasticity rules), homeostatic plasticity (scaling up of excitatory synapse strength, neurosynaptic element specific changes in inhibitory circuits, and changes in intrinsic excitability, depending on the precise deprivation/depression definition/paradigm, all to stabilize the neuron firing frequency ranges, and thus the network activity), structural plasticity (modify the network connectivity). Hence, compensation can be performed on different levels in both time and space, and across different framework modularity, along the different compute stack, on a circuit level, system and architecture level, across hardware and software lines.

Synaptic weight induced by Hebbian STDP co-activation deteriorate unless it is consolidated. The initial synaptic plasticity values may set a tag at the synapse, defining a marker for prospective consolidation (i.e. the transmission of information through a write process) when changes in synaptic efficacy occur. An intrinsic plasticity rule based on information-maximization principle is given as a non-limiting example below:

$$\frac{{dw}_{ij}}{dt} = \frac{χ}{{τ}_{w}} \overline{f} ( {w}_{ij} ) + \frac{{α}_{η w}}{4 {τ}_{w}} \overline{{g}_{ι j}} ( t ) ( {η}_{ij} - {w}_{ij} ) + σ {ξ}_{ij}^{w} ( t ) + {I}_{ij}^{w}$$

With wᵢⱼ a weight, tag ηᵢⱼ that are coupled to nearest neighbours via time-dependent gating variables as given by the formula above.

$${I}_{ij}^{w}$$

is the external input, χ is the homeostatic scaling factor,

$${ξ}_{ij}^{w}$$

are independent Gaussian white noise processes, α_{ηw} is the coupling parameter term which determine the strength of the interactions between the variables, τ_{w} is an associated time constant, and g acts as a gating variable. Furthermore, f is a (possibly discontinuous) function, that transforms the net current arriving at a population into the population activity, and designate the firing rates (in Hz). While the regulation time constants determine the direction in conductance space, the homeostatic scale factor controls a trajectory before reaching equilibrium. Here there is the assumption that a node can only excite its own inhibitory population. Neuronal membrane potential creates permissive time windows for induction of sensory context-dependent bidirectional plasticity mechanism. This plasticity rule that aims at different classes of excitatory and inhibitory synapse is consistent with an overall homeostatic shift in the balance between excitation and inhibition.

Synaptic scaling is mediated by multiple mechanisms that vary across various hierarchical levels by neurosynaptic type, time course, array region, and structural stage. The receptor types in the synaptic implementations are more diverse than the neurons they are connected to.

For the inference machine, which is more restricted in terms of neurosynaptic count, i.e., in the system where each uniformly defined receptor forming a synapse does not have dedicated neuron associated with a synaptic column, a neuron may be shared with a synaptic cluster incorporating a set of receptors that lead to the same final action. Consequently, the input signals offered the neuromorphic array are assembled for action, not by high level circuits, but by a dedicated neuron capable of offering complex functionality to enable economizing on neuron numbers.

The morphological features are considered as a specific control parameter that significantly contribute to both neurosynaptic elements dynamics and network activity patterns. Without loss of generality, the synaptic cluster forming in terms of size and function could be defined according to pre-defined contributions of subcellular morphological features to intracellular dynamics, such as specific signal processing functions and encoding scheme, specific data-rate, frequency band of interest, feature set or complexity, target SNR, time constants, et cetera.

This provides the paradigm shift in terms of how to provide sufficient resources for complex inference tasks within feasible power-performance-area design space, whether by increasing neurosynaptic count of simplified (or specialized) computation elements, or by increasing computational capabilities of (alternative complex, multi-functional) elements within reduced neurosynaptic count. Within these complex, multi-functional elements, a separate part for each task can be defined, i.e., synapse include diverse receptors, where each receptor can be independently tuned for speed, and sensitivity, can be regulated independently, and can offer more opportunities for further refinement, and redundancy for failure protection.

Without loss of generality, the complexity might include enabling (group of) neurosynaptic elements with nominally similar functionality, but supporting multiple pathways and enabled with subtly different properties, e.g. axons and astrocytes both express activation/refractory capabilities facilitated through diverging mechanisms. Nominally, communication and information transfer within the neural networks have been the sole province of pre- and post-synaptic coupling between neurons. However, the coupling of astrocytes and neurons provides an additional pathway for inter-cell communication; neuron to astrocyte communication is promoted by an additional synaptic compound released upon arrival of a presynaptic action potential.

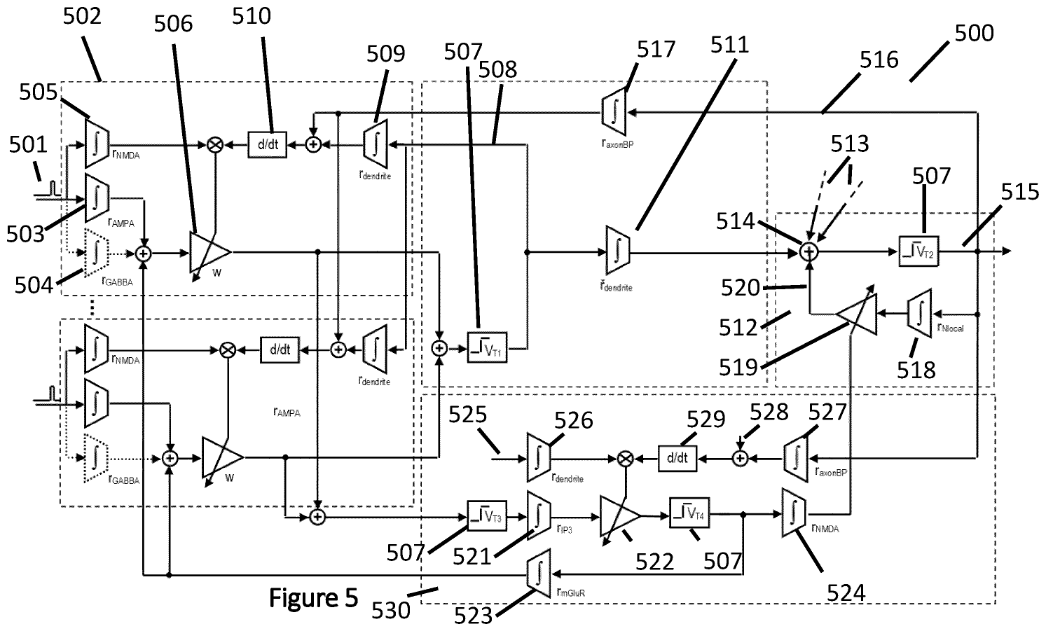

FIG. 5 shows a schematic representation of a reconfigurable modular network comprising of neuromorphic synapses with multiple receptors, adaptive exponential neurons, and an astrocytes system.

The present embodiment shows AMPA 503 and/or GABA 504 receptors, NMDA receptors 505, axon-516 and dendrite 508 back-propagation signal paths. Their workings are the same introduced above, and can function alone, or in the different combinations mentioned above for each synapse 502 connected to a input port 501.

Two new structures are introduced in the present embodiment, namely a neuron back-propagation signal path 520 and a astrocytes cell/structure 530.

The neuron 512 can thus comprise a neuron back-propagation signal path 520 connecting from the axon 515 of the neuron 512 to the soma of the neuron. For neural frequency/firing adaptation; when spiking frequency is high enough, the astrocyte uses the internal memory to reach a stable condition and consequently neural spiking frequency will be persistent. The neuron back-propagation signal path 520 may comprise a local receptor 518 configured to integrate the axon signal. The local receptor 518 may be a pure integrator element, and which is voltage driven. It may act as a filter for particular frequency ranges of the axon signal. Furthermore, the neuron-back propagation signal path 520 may comprise a calcium element 519 configured to set the influence of the integrated axon signal, thus creating a neuron feedback signal. The calcium element 519 may be a fast amplifier, preferably providing adaptable feedback. The neuron back-propagation signal path 520 is configured to feed the neuron feedback signal to the soma 514 of the neuron 512.

At the soma 514, the neuron feedback signal may be combined with the signal coming from the dendrite of a group of synapses 502 (which may be all the synapses connected to the neuron 512, or a subset) and/or signals coming from other segments 513 (which may have dendrite structures or not in between the synapses 502 and the neuron 512), similarly to the FIG. 4 embodiment.

The neurosynaptic structure 500 may comprise additionally or alternatively an astrocyte structure 530 connected to one or more multiple synaptic elements 502. The astrocyte structure 530 may be configured to receive and sum the postsynaptic signal of each of the multiple synaptic elements and can comprise a modulation circuit configured to modulate the summed postsynaptic signal into a modulated signal.

The astrocyte structure 530 may comprise an mGluR receptor 523 configured to integrate the modulated signal. Thereafter, the astrocyte structure may be configured to output the integrated modulated signal to each of the synaptic elements 502 (or a subset thereof). For example, each of the synaptic elements 502 (or a subset thereof) of which the postsynaptic signal was used the to-be-modulated input to the astrocytes structure can be configured to sum the integrated modulated signal received from the astrocytes structure with the integrated input signal by the AMPA 503 and/or a GABA 504 receptor.

Additionally or alternative to this feedback to the synaptic elements from the astrocytes structure, the astrocytes structure may comprise an NMDA receptor 524 configured to integrate the modulated signal coming from the modulation circuit. The NMDA receptor 524 can be similar to the NMDA receptor 505, but optimized differently, for example working on a different frequency domain. The astrocyte structure 530 may be configured to output the integrated modulated signal from the NMDA receptor 524 to the neuron 512 if the neuron back-propagation signal path 520 is present. The integrated modulated signal coming from the NMDA receptor 524 may modulate the calcium element of the neuron to change the influence of the integrated axon signal of the neuron coming from the local receptor 518 on the soma 514 of the neuron.

The modulation circuit of the astrocytes structure 530 may comprise an IP3 receptor 521 configured to integrate summed postsynaptic signal. The IP3 receptor 521 may be a pure integrator, which is voltage driven. Furthermore, the modulation circuit may comprise an astrocytic calcium element 522, which may be a fast amplifier, preferably providing adaptable feedback. The astrocytic calcium element 522 may configured to set the influence of the modulated signal. The IP3 receptor 521 and the astrocyte calcium element 522 may generate the modulated signal. Optionally, one or more signal restoration units 507 are present in the modulation circuit, which have similar workings to the signal restoration unit described above.

The astrocytic calcium element 522 may be adaptable in that it can be modulated. By modulating the astrocytic calcium element 522, one may change the influence of the modulated signal on the structures to which the astrocytes structure 530 provides feedback, e.g., the synaptic elements 502 or the neuron 512.

Pre-synaptic neuron signals or postsynaptic signals coming from synaptic elements which do not directly connect to the neuron 512 may be received at input 525 and integrated using a dendrite receptor 526. The dendrite receptor 526 may be similar to the dendrite receptor 509 or 511, but may also operate at a different frequency range, or have other differences in terms of its operating parameters.

An axon back-propagation signal may be integrated at an axon back-propagation receptor 527, which is similar to axon back-propagation receptor 517 in terms of its workings, but again may also operate at different frequency range, or have other differences in terms of its operating parameters. The integrated axon back-propagation signal may be combined with other axon back-propagation signals from post-synaptic neurons at input 528, or only the axon-back propagation signals from other post-synaptic neurons can be used as input. Preferably, a time derivative is taken of this (combined) axon input signal by a derivation unit 529, which is similar in workings to integration unit 510.

The input from the dendrite receptor 526 and the axon feedback may be combined (if both are present, but these can also be used on their own) e.g., by a multiplication unit, and the resulting signal can be fed to the astrocytes calcium element 522 in order to modulate the astrocytes calcium element. As mentioned, one may thus change the influence of the modulated signal on the structures to which the astrocytes structure 530 provides feedback, e.g., the synaptic elements 502 or the neuron 512.

Astrocytes cells used within spiking neurons in a spiking astrocyte-neuron network can perform distributed and fine-grained compensation and/or self-repair, e.g., if synaptic operation is interrupted, the retrograde control mechanism effectively re-starts the control and by the extension plasticity process.

Although astrocytes do not directly elicit propagating action potentials as neurons do, they can communicate in a bidirectional manner with neurons and other astrocytes. In synapses that includes a connection between an astrocyte and several neurons, i.e., a synapse exchanges signals at three terminals, when an action potential arrives accumulated charge is released across the synapse, causing a depolarization of the post-synaptic neuron.

The activation of astrocytic receptors leads to transient elevation in astrocytic intracellular calcium levels, which represent a fundamental mode of excitation in astrocytes, and astrocyte-neuron signalling, i.e., a slow inward current operating on much longer rise and decay times in comparison with typical excitatory postsynaptic current.

When the post-synaptic neuron is sufficiently depolarized, voltage-gated calcium channels on the dendrite allow the influx of calcium into the dendrite, which also enables control mechanism regulating backpropagated signal from the post-synaptic to the pre-synaptic terminal. Synaptically driven calcium transients in the astrocyte modulate synaptic transmission via the release of astrocytic glutamate (mGluR) that binds to presynaptic receptors. This then initiates the creation and release of IP3 within the astrocyte and triggers a transient intracellular release of calcium, and subsequently, leads to activation of NMDA receptors on the post-synaptic neuron.

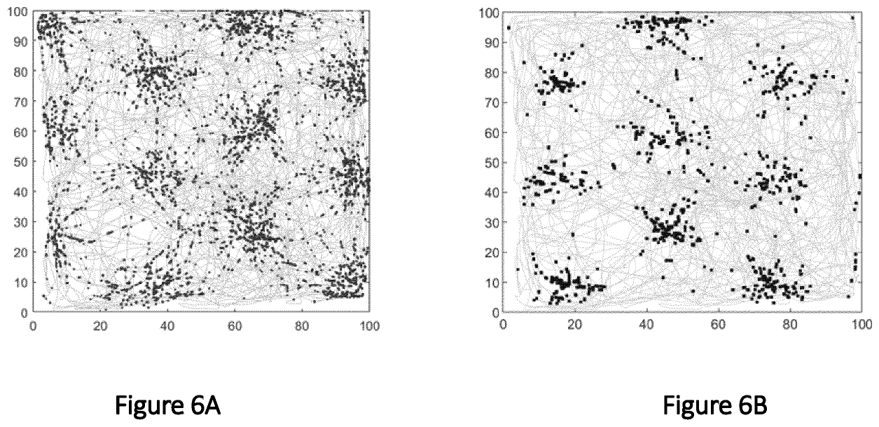

Astrocytes can also support the synchronization of neighboring neurons, or partial synchronization construct, which can be enhanced by increasing of inhibitory dynamics. In heterogeneous inhibitory networks with sparse random connectivity, inhibition dynamics offer duality in both suppressing the population activity, and producing a neural reactivation. Synchronization of spike transmission within circuits occurs when inputs from the excitatory neurons to the adjacent inhibitory neurons are sufficiently strong. The coupling strength is controlled by inhibitory innervation: when the inhibitory input is present, i.e. intermediate coupling, the neurons spike with diminutive rhythmicity/synchrony. The effect of this coupling is illustrated in FIG. 6A and FIG. 6B.

FIGS. 6A and 6B show coordinated events in a source population convey feedforward a) excitation, and b) inhibition; the shift to higher excitation/inhibition sets neurons in a fast/slow firing behavior with sparse bursts; for each synchrony partition a population of postsynaptic neurons is assigned; synchrony partitions are mapped to patterns of postsynaptic activity.

The duration selectivity curves are non-symmetrical to contend with heterogeneity in spike latency and resulting latency curves. The initial transient dynamics set through synaptic coupling guide the network towards the stationary dynamical regime. With increased coupling, a transition occurs from an ensemble of individually firing neurons to a coherent synchronized network. The neurons generate time-locked patterns; due to the interaction between conductance delay and plasticity rules, the network is forming a set of neuronal groups with reproducible and precise firing sequences, which are conditional to an activation pattern. As the conductance is increased (consequently, resulting in a net excitation to network), the firing rates increase and become more uniform with a lower coefficient of variation. The sequence of synaptic current, i.e., outward, inward, decreases temporal jitter in the generation of action potentials in individual neurons, and, consequently, create a network with increased controllability of a synchronized activity and homeostatic regulation.

Both graphs show position on both axes. By the invention the excitation (A) and inhibition (B) events are localized in space, as shown by black, bolt dots. If one were to overlay these figures, the regions in space where both excitation and inhibition occurs can be used to control the dynamics using both excitation and inhibition.

Note that features of any of the embodiments disclosed herein may be combined in an appropriate manner. For example, the different feedback and control structures disclosed above such as AMPA-, GABA-, and NMDA receptors, axon-, dendrite- and neuron back-propagation channels and the astrocytes structure may be taken by themselves or be combined in an appropriate manner. The same holds for the dendrite-, IP3-, mGluR-, local neuron- and axon back-propagation receptors, as well as the weight- and calcium elements, the derivation unit (differentiator) and the signal restoration units.

By way of example, receptors could be formed using gm-C filters, neural spike generators could be (positive-feedback enhanced) inverters, weight elements could be implemented through different (static or dynamic) memory elements (latches, leakage-compensated capacitor, SRAM cells, et cetera).

1. A neurosynaptic structure for a spiking neural network, wherein the neurosynaptic structure comprises a plurality of synaptic elements and a neuron, wherein each synaptic element comprises:
one or more input ports, each input port configured to receive an input signal;
an output port configured to output a post-synaptic signal; and
a signal path connecting the one or more input ports to the output port, the signal path including a weight element configured to apply a weight for generating the postsynaptic signal;
wherein the signal path of at least a portion of the synaptic elements includes an AMPA receptor configured to integrate the input signal to cause the postsynaptic signal to be more excitatory;
wherein the signal path of at least a portion of the synaptic elements includes a GABBA receptor configured to integrate the input signal to cause the postsynaptic signal to be more inhibitory; and
wherein the neuron comprises a soma and an axon, wherein the soma is configured to receive and combine one or more of the postsynaptic signals, and the axon is configured to generate a spike output when a membrane potential of the neuron reaches a predetermined threshold in response to an output of the soma.

2. The neurosynaptic structure of claim 1, wherein at least one of the synaptic elements comprises a signal path including both an AMPA receptor and a GABBA receptor, and wherein the at least one synaptic element is configured to combine outputs from the AMPA receptor and the GABBA receptor for generating the postsynaptic signal.

3. The neurosynaptic structure of claim 2, wherein the AMPA receptor and/or the GABBA receptor of the neurosynaptic elements are configurable to be active or passive at a particular moment, and/or wherein the AMPA receptor and/or the GABBA receptor of the neurosynaptic elements are configurable to select a frequency range of the input signal at which the AMPA receptor and/or the GABBA receptor are operable.

4. (canceled)

5. The neurosynaptic structure of claim 1, wherein the weight element is dynamically adjustable.

6. The neurosynaptic structure of claim 1, wherein the AMPA receptor comprises a voltage-driven integrator configured to generate an excitatory postsynaptic current for inducing charge influx from the membrane potential of the neuron, and/or the GABBA receptor is a voltage-driven integrator configured to generate an inhibitory postsynaptic current for inducing charge outflow from the membrane potential of the neuron.

7. A neurosynaptic structure for a spiking neural network, wherein the neurosynaptic structure comprises plurality of synaptic elements and a neuron, wherein each synaptic element comprises:
one or more input ports, each input port configured to receive an input signal;
an output port configured to output a post-synaptic signal; and
a signal path connecting the one or more input ports to the output port, the signal path including a weight element configured to apply a weight for generating the postsynaptic signal;
wherein the neuron comprises a soma and an axon, wherein the soma is configured to receive and combine one or more of the postsynaptic signals, and the axon is configured to generate a spike output when a membrane potential of the neuron reaches a predetermined threshold in response to an output of the soma;
wherein the neurosynaptic structure furthermore comprises an axon back-propagation signal path connected to receive an axon signal from the axon of the neuron;
wherein the axon back-propagation signal path comprises an axon back-propagation receptor configured to integrate the axon signal; and
wherein a first subset of the synaptic elements are configured to receive the integrated axon signal and modulate the weight element of the first subset of synaptic elements based on the integrated axon signal.

8. The neurosynaptic structure of claim 7, wherein each of the synaptic elements of the first subset of the synaptic elements comprises an NMDA receptor configured to integrate the input signal to form an integrated NMDA signal, and wherein the synaptic elements of the first subset of the synaptic elements are configured to combine the integrated NMDA signal and the integrated axon signal and modulate the weight element of the synaptic element based on the combined signal.

9-12. (canceled)

13. A neurosynaptic structure for a spiking neural network, wherein the neurosynaptic structure comprises a plurality of synaptic elements and a neuron, wherein each synaptic element comprises:
one or more input ports, each input port configured to receive an input signal;
an output port configured to output a post-synaptic signal; and
a signal path connecting the one or more input ports to the output port, the signal path including a weight element configured to apply a weight for generating the postsynaptic signal;
wherein the neuron comprises a soma and an axon, wherein the soma is configured to receive and combine one or more of the postsynaptic signals, and the axon is configured to generate a spike output when a membrane potential of the neuron reaches a predetermined threshold in response to an output of the soma;
wherein the neurosynaptic structure furthermore comprises a dendrite back-propagation signal path configured to receive and combine the postsynaptic signal from one or more of the synaptic elements;
wherein the dendrite back-propagation signal path comprises a dendrite receptor configured to integrate the combined postsynaptic signal; and
wherein a second subset of the synaptic elements is configured to receive the integrated combined postsynaptic signal and modulate the weight element of the second subset of the synaptic elements based on the integrated combined postsynaptic signal.

14. The neurosynaptic structure of claim 13, wherein each of the synaptic elements of the second subset of the synaptic elements comprises an NMDA receptor configured to integrate the input signal to form an integrated NMDA signal, and wherein the synaptic elements of the second subset of the synaptic elements are configured to combine the integrated NMDA signal and the integrated combined postsynaptic signal and modulate the weight element of the synaptic element based on the combined signal.

15. The neurosynaptic structure of claim 13, wherein the integrated combined postsynaptic signal is time-differentiated by a derivation unit before the differentiated integrated summed postsynaptic signal is used to modulate the weight element.

16. (canceled)

17. The neurosynaptic structure of claim 13, wherein the neuron is configured to receive the one or more postsynaptic signals from the one or more synaptic elements at the soma via a second dendrite receptor which integrates the combined postsynaptic signal of each of the one or more synaptic elements.

18. The neurosynaptic structure of claim 13, wherein the one or more postsynaptic signals are combined at the soma by combining the combined postsynaptic signal of each of the synaptic elements in the second subset with one or more postsynaptic signals from the one or more synaptic elements not in the second subset.

19. (canceled)

20. A neurosynaptic structure for a spiking neural network, wherein the neurosynaptic structure comprises a plurality of synaptic elements and a neuron, wherein each synaptic element comprises:
one or more input ports, each input port configured to receive an input signal;
an output port configured to output a post-synaptic signal; and
a signal path connecting the one or more input ports to the output port, the signal path including a weight element configured to apply a weight for generating the postsynaptic signal;
wherein the neuron comprises a soma and an axon, wherein the soma is configured to receive and combine one or more of the postsynaptic signals, and the axon is configured to generate a spike output when a membrane potential of the neuron reaches a predetermined threshold in response to an output of the soma;
wherein the neuron comprises a neuron back-propagation signal path connecting from the axon of the neuron to the soma of the neuron and comprising a local receptor configured to integrate the axon signal and a calcium element configured to set the influence of the integrated axon signal thus creating a neuron feedback signal, and wherein the neuron back-propagation signal path is configured to feed the neuron feedback signal to the soma of the neuron where the neuron feedback signal is combined with the one or more postsynaptic signals.

21-23. (canceled)

24. A neurosynaptic structure for a spiking neural network, wherein the neurosynaptic structure comprises a plurality of synaptic elements and a neuron, wherein each synaptic element comprises:
one or more input ports, each input port configured to receive an input signal;
an output port configured to output a post-synaptic signal; and
a signal path connecting the one or more input ports to the output port, the signal path including a weight element configured to apply a weight for generating the postsynaptic signal;
wherein the neuron comprises a soma and an axon, wherein the soma is configured to receive and combine one or more of the postsynaptic signals, and the axon is configured to generate a spike output when a membrane potential of the neuron reaches a predetermined threshold in response to an output of the soma;
wherein the neurosynaptic structure comprises an astrocyte structure connected to a third subset of the synaptic elements;
wherein the astrocyte structure is configured to receive and sum the postsynaptic signals of each of the synaptic elements and comprises a modulation circuit configured to modulate the summed postsynaptic signal into a modulated signal;
wherein the modulated signal is used to change the behaviour at one or more of the synaptic elements of the third subset or at the neuron.

25. The neurosynaptic structure of claim 24, wherein the astrocyte structure comprises an mGluR receptor configured to integrate the modulated signal, and wherein the astrocyte structure is configured to output the integrated modulated signal to each of the synaptic elements in the third subset, and wherein each of the multiple synaptic elements is configured to combine the integrated modulated signal with an integrated input signal, wherein the integrated input signal is obtained from integrating the input signal using an AMPA and/or a GABBA receptor positioned along the signal path configured to integrate the input signal.

26. (canceled)

27. The neurosynaptic structure of claim 24, wherein the astrocyte structure comprises an NMDA receptor configured to integrate the modulated signal, and wherein the astrocyte structure is configured to output the integrated modulated signal to the neuron.

28. The neurosynaptic structure of claim 27, wherein the neuron comprises a neuron back-propagation signal path connecting the axon to the soma of the neuron and comprising a calcium element configured to set the influence of the integrated axon signal to create a neuron feedback signal, and wherein the neuron back-propagation signal path is configured to feed the neuron feedback signal to the soma of the neuron, and
wherein the integrated modulated signal modulates the calcium element of the neuron to change the influence of the integrated axon signal of the neuron.

29. The neurosynaptic structure of claim 24, wherein the modulation circuit comprises an IP3 receptor configured to integrate the summed postsynaptic signal and an astrocyte calcium element configured to set the influence of the modulated signal, wherein the IP3 receptor and the astrocyte calcium element generate the modulated signal.

30. (canceled)

31. The neurosynaptic structure of claim 29, wherein the neurosynaptic structure comprises synaptic elements which do not directly connect with the neuron, and wherein the astrocyte calcium element is modulated using pre-synaptic neuron signals or postsynaptic signals coming from the synaptic elements which do not directly connect with the neuron and which are integrated using a dendrite receptor.

32. The neurosynaptic structure of claim 29, wherein the axon of the neuron is connected to the astrocyte structure, so that an axon back-propagation receptor of the astrocyte is configured to integrate the axon signal of the neuron and wherein the integrated axon signal is used to modulate the astrocyte calcium element.

33-34. (canceled)
